(19) United States
(12) Patent Application Publication
(10) Pub. No.: US 2026/0132989 A1
(43) Pub. Date: May 14, 2026

(54) SYSTEMS AND METHODS FOR VACUUM-ASSISTED DEEP WASTE HEAT RECOVERY

(71) Applicant: T2M Global LLC, Brookfield, CT (US)

(72) Inventors: Pinakin Patel, Danbury, CT (US); Ludwig Lipp, Brookfield, CT (US)

(21) Appl. No.: 18/948,395

(22) Filed: Nov. 14, 2024

(51) Int. Cl. F27D 17/00

(52) U.S. Cl. CPC F27D 17/10; F27D 17/15

(57) ABSTRACT

Systems, devices, and methods comprising: a heat exchanger including: a shell including a first section and a second section, where one of the first section and the second section is one or more tubes disposed inside the shell, and the other is a void surrounding the one or more tubes inside the shell; the first section configured to receive hot fluid and recover heat from the hot fluid; the second section configured to receive cold fluid and generate steam using the recovered heat; a vacuum pump configured to lower a pressure of the second section inside the shell and receive the steam from the second section; and a vapor compressor configured to receive the steam from the vacuum pump and pressurize the steam.

### TECHNICAL FIELD

Embodiments relate generally to systems and methods for the recovery of low-level waste heat.

### BACKGROUND

Low-level waste heat may refer to relatively mild heat produced as a byproduct of in various industrial processes, typically not hot enough for direct use but still significant enough to be captured and recovered for energy efficiency improvements. This low-level waste heat is currently a stranded resource and underutilized due to technological and economic limitations. Cost-effectively capturing and utilizing this low-level waste heat, including both sensible and latent heat, is hindered by four main restrictions, such as low driving force, material compatibility and limitations of material, lack of appropriate end use, manufacturing challenges, and others.

As conventional solutions, various strategies have been employed to solve the challenge of recovering and utilizing the latent heat from natural gas combustion, particularly focusing on the condensation of water vapor and handling of chemically active condensates. Many solutions have primarily concentrated on improving the durability and longevity of heat exchangers by utilizing materials like stainless steel, coated metals, and advanced polymers that resist corrosion. While these enhancements are crucial for maintaining the integrity of the systems in corrosive environments, they fall short in addressing other significant restrictions to the adoption of low-level waste heat recovery systems, such as the issue of the low driving force, the use in confined area, variable means in industrial processes, and others.

### SUMMARY

The embodiments of the present disclosure comprise: a heat exchanger including: a shell including a first section and a second section, wherein one of the first section and the second section is one or more tubes disposed inside the shell, and the other is a void surrounding the one or more tubes inside the shell; the first section configured to receive hot fluid and recover heat from the hot fluid; the second section configured to receive cold fluid and generate steam using the recovered heat; a vacuum pump configured to lower a pressure of the second section inside the shell and receive the steam from the second section; and a vapor compressor configured to receive the steam from the vacuum pump and pressurize the steam.

A system embodiment may include: a heat exchanger including: a shell including a first section and a second section, where one of the first section and the second section may be one or more tubes disposed inside the shell, and the other may be a void surrounding the one or more tubes inside the shell; the first section configured to receive hot fluid and recover heat from the hot fluid; the second section configured to receive cold fluid and generate steam using the recovered heat; a vacuum pump configured to lower a pressure of the second section inside the shell and receive the steam from the second section; and a vapor compressor configured to receive the steam from the vacuum pump and pressurize the steam.

In additional system embodiments, the vacuum pump may be connected to the second section inside the shell, and where the vapor compressor may be connected to the vacuum pump. In additional system embodiments, the recovered heat includes both sensible heat and latent heat that may be recovered from the hot fluid.

In additional system embodiments, the latent heat may be generated by condensation of water vapor present in the hot fluid inside the one or more tubes through heat exchange with the cold fluid inside the void surrounding the one or more tubes.

In additional system embodiments, the steam may be generated by vaporization of the cold fluid inside the second section using at least one of the sensible heat and latent heat transferred from the first section, under a lowered pressure by the vacuum pump. In additional system embodiments, the lowered pressure inside the second section lowers a boiling point of the cold fluid. In additional system embodiments, a pressure inside the void inside the shell may be lower than a pressure inside the one or more tubes.

In additional system embodiments, the system may be connected to a boiler, where the hot fluid may be exhaust gas expelled from the boiler, and the cold fluid may be boiler feed water. In additional system embodiments, the pressurized steam has an increased pressure and may be supplied to the boiler for reuse.

In additional system embodiments, the one or more tubes may be made of a plastic material.

In additional system embodiments, the one or more tubes may be made of at least one of: Polypropylene, Polyethylene, Ethylene tetrafluoroethylene, Polytetrafluoroethylene, Polyether Ether Ketone, Ethylene Chlorotrifluoroethylene, Fluorinated Ethylene Propylene, Liquid Crystal Polymer, Polyamide, Nylon, Polybenzimidazole, Polychlorotrifluoroethylene, Polyetherimide, Polyether sulfone, Polyimide, Polymethylpentene, Polyoxymethylene, Polyphenylene sulfide, Polyphenylsulfone, Polypropylene Homopolymer, Polysulfone, and Polyvinylidene fluoride.

Additional system embodiments may include: a phase separator, where the phase separator may be connected to the first section and configured to separate condensates from non-condensable fluid in the hot fluid.

A method embodiment may include: receiving hot fluid via a first section of a heat exchanger; receiving cold fluid inside a second section of a heat exchanger; lowering a pressure inside the second section by a vacuum pump; recovering heat from the hot fluid through heat exchange with the cold fluid; generating steam inside the second section using the recovered heat; and pressurize the steam by a vapor compressor, where one of the first section and the second section may be one or more tubes disposed inside a shell of the heat exchanger, and the other of the first section and the second section may be a void surrounding the one or more tubes inside the shell.

In additional method embodiments, the recovered heat includes both sensible heat and latent heat. In additional method embodiments, the recovered heat may be generated by condensation of water vapor present in the hot fluid inside the first section.

In additional method embodiments, the steam may be generated by vaporization of the cold fluid inside the second section using at least one of sensible heat and latent heat of the recovered heat transferred from the first section, under a lowered pressure by the vacuum pump.

In additional method embodiments, the lowered pressure inside the second section lowers a boiling point of the cold fluid. In additional method embodiments, the hot fluid may be exhaust gas expelled from a boiler, and the cold fluid may be boiler feed water, and where the method further comprises: supplying the pressurized steam to the boiler for reuse. In additional method embodiments, the first section may be made of a plastic material.

Additional method embodiments may include: separating condensates from non-condensable fluid in the hot fluid by a phase separator connected to the first section.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1A depicts a schematic diagram of a vacuum-assisted deep waste heat recovery (VDR) system, according to one embodiment;

FIG. 1B depicts a graph for low-level waste heat recovery in conventional heat recovery systems;

FIG. 2 depicts major components of a VDR system, including a plastic heat exchanger (P-HEX), a vacuum pump, and a vapor compressor, according to one embodiment;

FIG. 3A depicts a schematic structure of a VDR system, according to one embodiment;

FIG. 3B depicts a cross section view of a P-HEX of a VDR system, according to one embodiment;

FIG. 3C depicts a schematic structure of a VDR system, according to one embodiment;

FIG. 4 depicts a VDR system integrated with a boiler, according to one embodiment;

FIG. 5 depicts a schematic structure of a P-HEX to explain an operating window of the P-HEX, according to one embodiment;

FIG. 6 depicts a comparison of tube diameters of a conventional heat exchanger and a P-HEX, according to one embodiment;

FIG. 7 depicts a graph for showing an operating window of a VDR system for water with respect to temperature and pressure, according to one embodiment; and

FIG. 8 is a table for showing test performances of a P-HEX in real environment, according to one embodiment.

### DETAILED DESCRIPTION

The systems and methods for vacuum-assisted deep waste heat recovery comprise: a heat exchanger including a shell including a first section and a second section, wherein one of the first section and the second section is one or more tubes disposed inside the shell, and the other is a void surrounding the one or more tubes inside the shell; the first section configured to receive hot fluid and recover heat from the hot fluid; the second section configured to receive cold fluid and generate steam using the recovered heat; a vacuum pump configured to lower a pressure inside the second section to the extent that boiler feed water is vaporized at a predetermined temperature with the latent heat to generate steam; and a vapor compressor configured to receive the steam from the second section and pressurize the steam. In some embodiments, the one or more tubes may be made of plastic.

The systems and methods can effectively recover over approximately 80% of low-level sensible and latent waste heat and upgrade it to higher-value steam. In addition, the integrated system design of plastic heat exchanger (P-HEX), a vacuum pump, and a vapor compressor in a VDR system may allow both the driving force benefits of the temperature gradient and the pressure gradient. Furthermore, plastic tubes for heat transfer of the P-HEX dramatically increases the surface area for heat exchange and the waste heat recovery. Moreover, the vacuum pump may create a lower pressure environment, allowing for the vaporization of boiler feed water at temperatures below its boiling point. The vapor compressor also allows the VDR system to not only recover waste heat but also upgrade it to standards required for industrial processes, enhancing the usability of recovered energy. Additionally, the VDR system may minimize physical footprint and significantly reduce its weight, leading to competitive capital and operating costs.

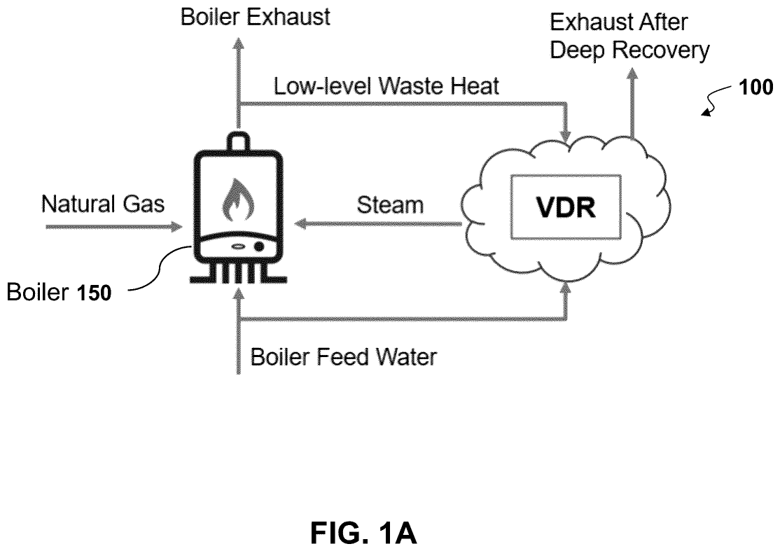

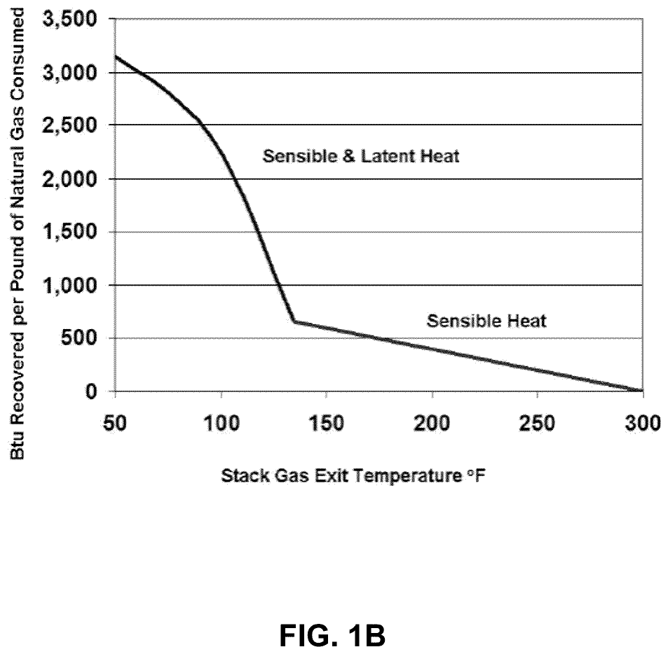

FIG. 1A depict a schematic diagram of a vacuum-assisted deep waste heat recovery (VDR) system 100 with a boiler 150, according to one embodiment. The “deep waste heat recovery” may imply the recovery of waste heat that is unrecoverable by conventional means due to economic or technical reasons (i.e. latent heat, low-temperature heat). The VDR system 100 is utilized to recover sensible and latent heat for improving boiler efficiencies. Referring to FIG. 1A, the boiler 150 and the modular VDR system 100 for improving boiler efficiencies are illustrated. The modular VDR system 100 may be an integrated system of a plastic heat exchanger (P-HEX), a vacuum pump, and a vapor compressor. When the boiler 150 generates steam with natural gas and boiler feed water, it may produce combustion gases and heat and expel this boiler exhaust gases (e.g. waste gases and heat). The P-HEX may be provided with the boiler exhaust gases with low-level waste heat from the boiler 150 and operated to recover heat and generate steam using both the sensible and latent heat of exhaust gas before vaporization of the boiler feed water under a lower pressure environment formed by the vacuum pump. Then, the vapor compressor upgrades the generated steam to higher-temperature and pressure steam. The generated high temperature steam may be returned to the boiler 150 for reuse. After this deep recovery process, the VDR system 100 may expel a small amount of exhaust to the outside.

In some embodiments, the VDR system 100 may be modular. The modular VDR system 100 may comprise distinct, self-contained units or modules. Each unit or module of the VDR system 100 can function independently but can also be combined with others to form a larger, integrated system. The components of each unit or module may be scalable and deployable with relatively low efforts. For example, a building block heat exchanger unit or module may be integrated into multiple series and/or parallel configurations. The integration of multiple units or modules may create significant capacity scale-up while using the same size building block unit. This approach allows easier capacity addition and offers lower manufacturing cost.

The VDR system 100 may recover over approximately 80% of all low-level industrial waste heat, including latent and sensible heat, and upgrade it to higher-value steam for reuse. The VDR system 100 enables boiler thermal efficiencies of up to approximately 95%, matching and exceeding the capabilities of the most efficient condensing economizers. The condensing economizer may be a conventional device that works together with a boiler to enhance energy efficiency in a heating systems. The condensing economizer may be a heat exchanger that functions similarly to the P-HEX component of the VDR system, in that it recovers the latent heat from exhaust gas. However, the condensing economizer does not operate with the boiler feed water under vacuum to reduce the boiling point temperature, and the steam is not upgraded to a higher pressure via compression.

FIG. 1B depicts a graph of waste heat recovery on a VDR system according to temperature of exhaust gases, according to embodiments. The graph represents waste heat that is recovered by the VDR system. The x-axis indicates stack gas exit temperature (° F.) and the y-axis indicates a recovered amount of heat in British Thermal Unit (BTU) per pound of natural gas consumed. The stack gas exit temperature may detail the temperature of the low-level waste heat source. This may be the driving force for the operation of the VDR system and may be the same temperature as the exhaust gases. The graph represents the thermal energy that is left unrecovered in boiler exhaust gas. The VDR system recovers waste heat with a temperature even below approximately 150° F. while conventional heat recovery systems do not operate even below 300° F.

According to the VDR system, from approximately 150 to 300° F., only sensible heat may be recovered. The dew point temperature of the water vapor in the exhaust gas may be around 150° F., with slight variability based upon the quantity of water vapor in exhaust gas. As water starts condensing out around 150° F., it releases thermal energy in the form of latent heat. Accordingly, the low-level waste heat, which is below approximately 150° F., is recovered from sensible and latent heat. Over approximately 75% of total waste heat may come from latent heat; however, the latent heat may be more difficult to recover for reuse. Latent heat involves the energy absorbed or released during phase changes, such as water vapor condensing. This process can be complex and often produces corrosive condensates, necessitating specialized and more costly equipment. Therefore, despite its substantial share, latent heat is difficult to recover and reuse effectively. According to the VDR system, the use of vacuum increases the driving force and enables recovery of latent heat.

FIG. 1B illustrates a typical example of how much heat is recoverable. It is the subject of this invention to recover latent heat, as well as sensible heat. It is the source temperature that determines the driving force for transferring the heat for the cold fluid. As the heat is transferred and the cold fluid increases in temperature, the driving force (differential temperature; ΔT) decreases. This increases the heat transfer surface area requirement and makes recovery of heat difficult, particularly latent heat. Use of vacuum increases this ΔT and makes it recoverable.

In general, the combustion of natural gas, used in boilers for example, is inherently inefficient, with approximately 20% of the energy content of the gas lost as low-grade waste heat, primarily in the form of water vapor. This significant energy loss occurs because the reaction of methane with oxygen not only produces carbon dioxide but also yields a substantial amount of water vapor, according to the chemical equation:

$${CH}_{4} + 2 {O}_{2} {\to }^{Δ H} {CO}_{2} + 2 {H}_{2} O ; Δ H = - 891 kJ / mol \qquad ( 1 )$$

For every pound of natural gas combusted, approximately 2.25 pounds of water vapor are produced, carrying away a significant amount of energy as latent heat (˜approximately 2,250 BTU of heat). This energy from latent heat remains unutilized unless the vapor is effectively condensed and the heat is recovered. In natural gas-fired boilers, the flue gas may only be cooled to a minimum of approximately 250° F. (121° C.), resulting in the loss of both sensible and latent heat. Furthermore, the condensation of water vapor from natural gas exhaust often results in chemically active condensates that are corrosive to conventional metallic heat exchangers (M-HEX), which limits their useful life. These systems also demand a substantial surface area to operate efficiently at lower temperatures. Additionally, there is a significant challenge in finding suitable end uses for this recovered waste heat, particularly as the temperature of the heat source drops below approximately 212° F. (100° C.), limiting its applicability and effectiveness in further applications.

Thus, cost-effectively capturing and utilizing this low-level waste heat, including both sensible and latent heat, is hindered by four main restrictions. First, the low driving force may be one restriction. As the temperature difference between the heat source and the sink that receives heat narrows, the surface area required for heat transfer escalates dramatically. This relation between the temperature difference and heat exchange surface area is given by the following equation where Q is the heat exchanged, U is the overall heat transfer coefficient, A is the heat transfer surface area, and ΔT is the temperature difference (or driving force).

$$Q = UA Δ T \qquad ( 2 )$$

The requirement for increasing the heat exchange surface area may also increase the capital cost of M-HEXs from less than $100/kWth to more than $1,000/kWth. This leads to incredibly large and heavy heat exchangers that are difficult to ship, install, and service.

Second, there is issues for material compatibility and limitations. The low-temperature heat steams frequently contain corrosive elements that damage materials used in traditional M-HEX, such as aluminum, copper, or steel. This leads to conditions conducive to corrosion and fouling of the M-HEX. Although the use of protective coatings, stainless steel, or superalloys may mitigate these issues, such solutions are prohibitively expensive. For example, highly acidic condensates may require prohibitively expensive M-HEX. The high costs of these materials capable of withstanding such corrosive environments and their manufacturing complexity prevent the economical recovery of low-temperature heat.

Third, there are reuse challenges, and appropriate end use may be limited. Many industrial facilities do not have an on-site use for low temperature waste heat. For example, waste heat may be available in the form of hot water at approximately 90° F. (32° C.), while hot water at approximately 180° F. (82° C.) is needed elsewhere in the facility. Current technologies that create end-use options are prohibitively expensive at larger scales.

Fourth, there are also manufacturing challenges. The packing density of tubes for surface area is a major challenge for M-HEX as the welding and/or joining of the smaller diameter tubes requires complex tooling, fixtures, and processing steps. Additionally, the manufacturing cost increases exponentially for smaller diameter, thinner wall tubes. Thus, manufacturing techniques are not capable of increasing the surface area packing density of M-HEX to the extent required to recover low-level waste heat while maintaining the required footprint.

These restrictions above lead to significant energy losses and associated increased operational costs across multiple industries. Vented waste heat requires additional fuel, such as natural gas, to compensate for the losses. The waste heat is typically discharged in a cooling tower, adding to system complexity, cost, and footprint. There is also an environmental impact of higher carbon emissions due to less optimized energy use.

In the conventional systems and methods, various strategies have been employed to solve the challenge of recovering and utilizing the latent heat from exhaust gases of natural gas combustion, particularly focusing on the condensation of water vapor and handling of chemically active condensates. Specifically, deep economizers are designed to cool natural gas combustion exhaust gas to approximately 150 to 160° F. (65° C. to 71° C.) while withstanding the chemically active condensate that deposits on its surface. These devices may also include the additional configurations. For example, a “throwaway” section is installed on the cold end of the economizer. The tubing in the cold end may degrade over time and may need to be repeatedly replaced. The frequency of replacements may depend on the flue gas composition and the material of construction. In another example, the economizer is designed with stainless steel tubes. Stainless steel withstands acidic gases better than the mild steel typically used in construction. In another example, carbon steel is used for the majority of the heat exchanger, but stainless steel tubes is used in the cold end where acidic deposits will occur. In other examples, glass-tubed heat exchangers or advanced materials such as Teflon or Nafion are used. There are also direct contact condensation recovery techniques. The direct contact condensation recovery involves direct mixing of the process stream and cooling fluid. As flue gases enter the heat exchanger, they are cooled by cold water introduced at the top of the unit. The heated water stream exits through the bottom of the exchanger and provides heat to an external system. The conventional systems or methods also include transport membrane condensers. These transport membrane condensers are a developing technology for capturing water along with latent heat from the water vapor in gas exhaust streams. Water is extracted from the flue gas at temperatures above the dew point by employing capillary condensation and recycled into the boiler feedwater. The device consists of ceramic supports and costly Nafion membranes.

As mentioned above, many conventional solutions have primarily concentrated on improving the durability and longevity of heat exchangers by utilizing materials like stainless steel, coated metals, and advanced polymers that resist corrosion. While these enhancements are crucial for maintaining the integrity of the systems in corrosive environments, they fall short in addressing other significant restrictions to the adoption of low-level waste heat recovery systems. Firstly, these conventional solutions do not adequately solve the issue of the low driving force in heat exchange processes. These solutions have not sufficiently increased surface area, thus limiting the practical application and efficiency of these heat exchangers. Secondly, the conventional solutions are highly restrictive in their physical footprint and do not fit well into confined areas. This prevents their practical use in environments where space is limited, such as in industrial facilities, power plants, or onboard systems in the maritime sectors. The cumbersome size and weight of conventional solutions make it difficult to integrate them into existing infrastructures without significant modifications or expansions, which can be cost-prohibitive and logistically challenging. Finally, these conventional solutions fail to provide a viable means of utilizing this heat in a way that adds value or efficiency to industrial processes. Without practical applications for the recovered heat, the potential benefits of energy savings and reduced environmental impact are not fully realized. This creates a gap in the solution landscape. In the specific case of the transport membrane condenser among the conventional solutions, while effective as a solution, there were issues preventing their practical use. The ceramic supports were not capable of withstanding the high vibration environment in which they were utilized, such as boiler rooms. Additionally, the Nafion membranes were prone to contamination by components found in typical combustion exhaust streams. Thus, while the conventional solutions have resolved some material challenges associated with low-level heat recovery, they have not completely solved the problems associated with recovering and utilizing latent heat from combustion exhaust.

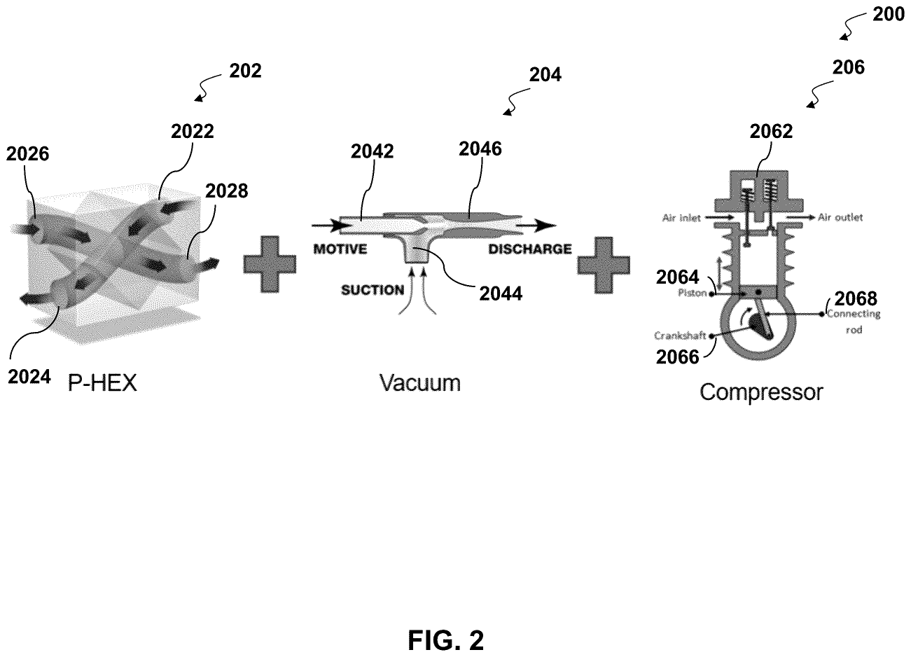

FIG. 2 depicts major components of a VDR system 200, including a plastic heat exchanger (P-HEX) 202, a vacuum pump 204, and a vapor compressor 206, according to one embodiment. The components of the VDR system 200 may allow to replace costly conventional systems (e.g. metallic heat exchanger (M-HEX)) and/or delicate ceramic heat exchangers with an efficient, resilient, and lower-cost plastic heat exchanger (P-HEX) 202. The VDR system 200 may facilitate the vacuum pump 204 to capture latent heat and the vapor compressor 206 to pressurize or compress steam for reuse in a boiler.

Specifically, the vacuum pump 204 may be generated by a rotary pump, ejector, or both to create the vacuum. Utilizing the vacuum pump 204, the VDR system 200 may capture latent heat from exhaust gases more effectively. The vacuum may create a lower pressure environment inside the P-HEX 202, specifically the section where the boiler feed water is contained, allowing for the vaporization of boiler feed water at temperatures below its boiling point of approximately 212° F. (100° C.).

The vapor compressor 206 may include a rotating compressor, an ejector, or multiples of them combined for multi-stage compression, suitable for boilers operating at higher pressures. The vapor compressor 206 may have two functions: pressurizing and super-heating the steam. The vapor compressor 206 may serve to pressurize the steam containing the recovered heat into a more valuable form. That is, the vapor compression in the VDR system may allow heat to be upgraded. The heat of compression may superheat the steam while preventing any condensation due to pressurization. This allows the VDR system 200 to not only recover waste heat but also upgrade it to standards required for industrial processes, enhancing the usability of recovered energy.

That is, the VDR system 200 may extract latent heat from exhaust gases and facilitate the vaporization of boiler feed water at significantly lower temperatures, which may be under approximately 100° C. (212° F.). The latent heat recovery from hot fluids (exhaust gas) to supply the latent heat requirements of boiler feed water may be the key innovation of VDR system. Thus, the synergistic integration of the P-HEX 202, vacuum pump 204, and vapor compressor 206 may allow the VDR system 200 to dramatically broaden the range of low-level waste heat for deep recovery. The waste heat may be recovered as a low-pressure steam and then upgraded to match the host site integration requirements.

Specifically, the P-HEX 202 may include a hot fluid inlet 2022, a hot fluid outlet 2024, a cold fluid inlet 2026, and a cold fluid outlet 2028, which are the points where fluids enter and exit the P-HEX 202. The hot fluid inlet 2022 may be an inlet for the hot fluid (e.g. exhaust gas), and the hot fluid outlet 2024 may be an outlet for this hot fluid. For simplicity's sake, the fluid exiting from the outlet 2024 is referred to as hot fluid even though it is cooled. The cold fluid inlet 2026 may be an inlet for the cold fluid (e.g. boiler feed water), and the cold fluid outlet 2028 may be an outlet for this cold fluid. For simplicity's sake, the fluid exiting from the outlet 2028 is referred to as cold fluid even though it is heated. In some embodiments, the P-HEX 202 may include a shell including a first section and a second section, and one of the first section and the second section is one or more tubes disposed inside the shell, and the other is a void surrounding the one or more tubes inside the shell. In this case, the one or more tubes may be formed with a plastic tube, and thus, the diameter of each tube may be significantly reduced. This tube structure may lead to the increases in tube packing density and heat exchange surface area. Since the P-HEX 202 has the significantly increased surface area for heat exchange and tube packing density, the VDR system 200 may also minimize physical footprint and significantly reduce its weight, leading to competitive capital and operating costs.

The vacuum pump 204 may include a motive line 2042, a suction line 2044, and a discharge line 2046. Through the motive line 2024, motive fluid (typically steam) may enter the vacuum pump 204 to create the necessary pressure differential. The suction line 2044 may draw in the low-pressure steam from the P-HEX 202. Through the discharge line 2046, the steam may be expelled. The vacuum pump 204 shown in FIG. 2 is an example of one type of vacuum that may be used, but the present disclosure is not limited thereto. The vacuum condition in the VDR system may be formed with another type of vacuum device.

The vapor compressor 206 may include a cylinder head and valve assembly 2062, a piston 2064, a crankshaft 2066, and a connecting rod 2068. The cylinder head and valve assembly 2062 may include the cylinder head and valve assembly, crucial for enclosing the cylinder and controlling the intake and exhaust of air or vapor. It ensures the proper flow of vapor into the cylinder for compression and expulsion. The piston 2064 may move within the cylinder, compressing the steam. It may be connected to the crankshaft 2066 and connecting rod 2068, converting rotational motion into reciprocating motion. The crankshaft 2066 may convert the rotary motion of the motor into the reciprocating motion of the piston 2064. The connecting rod 2068 may connect the piston 2064 to the crankshaft 2066, transmitting the motion required for compression. The vapor compressor 206 shown in FIG. 2 is an example of one type of compressor that may be used, but the present disclosure is not limited thereto. The compressor in the VDR system may be formed with another type of compressor device.

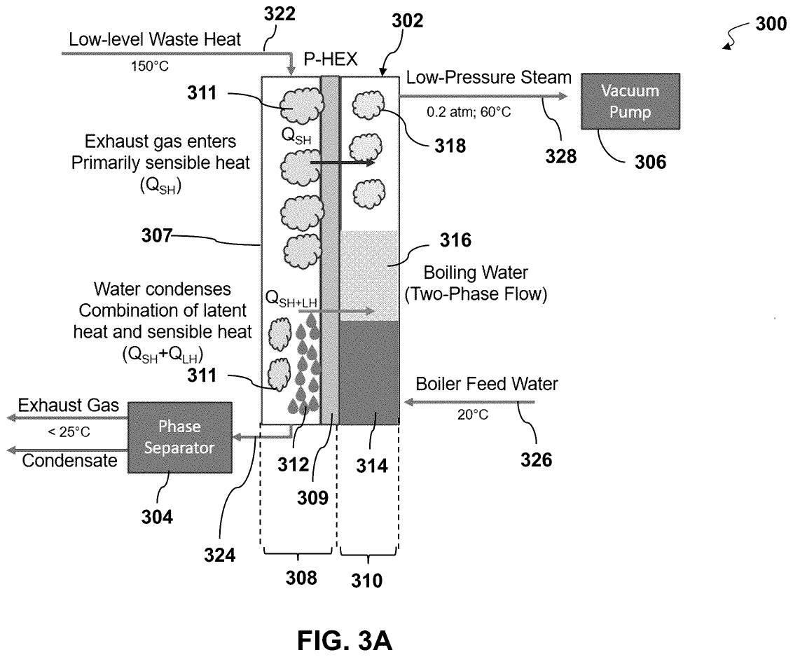

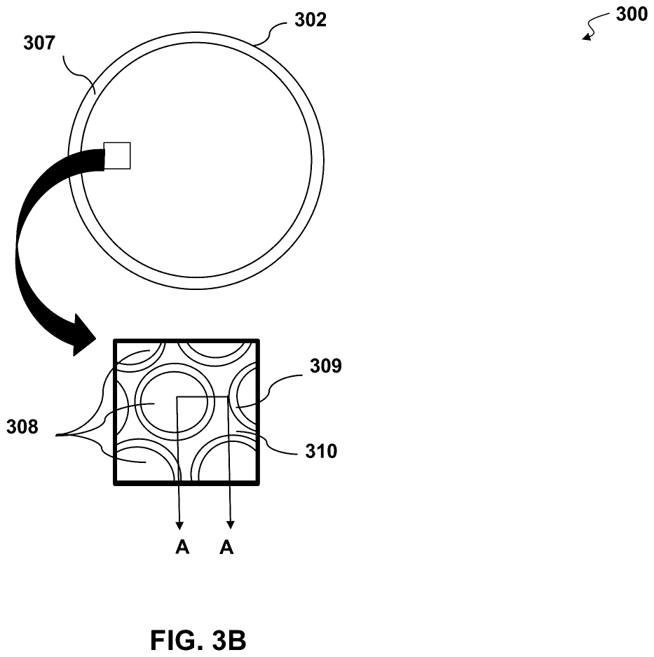

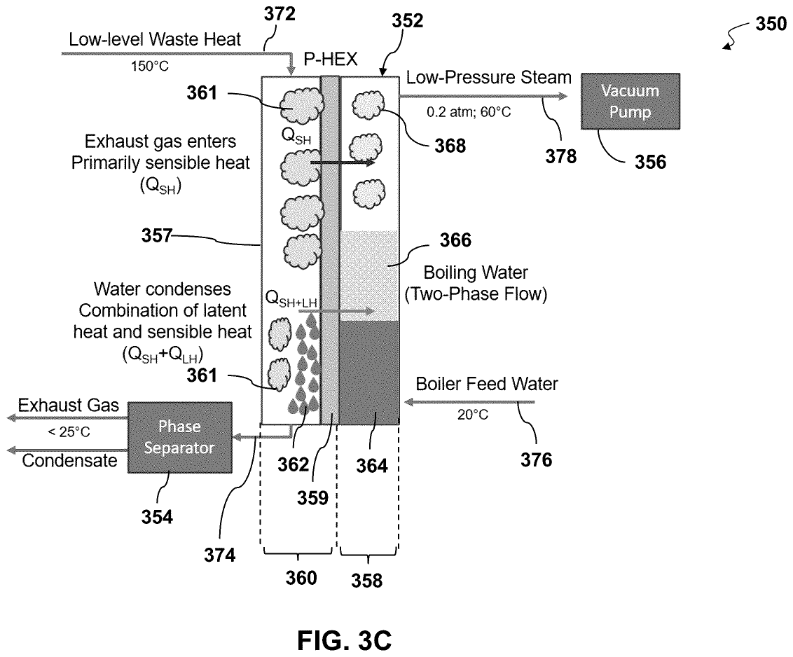

FIG. 3A depicts a schematic structure of a VDR system 300, according to one embodiment. FIG. 3B depicts a cross section view of a P-HEX 302 of the VDR system 300, according to one embodiment. The P-HEX 302 shown in FIG. 3A may be a cross section viewed from A-A line in FIG. 3B. Referring to FIGS. 3A and 3B, the VDR system 300 may include a P-HEX 302, a phase separator 304, a vacuum pump 306, and a vapor compressor (not shown). The P-HEX 302 may include a cylindrical shell 307 and a tube bundle including a plurality of tubes 308 with thin walls 309 inside the shell 307. The P-HEX 302 also includes a void 310 in between the plurality of tubes 308, and the tube wall 309 is located in between the inside of the tube 308 and the void 310. The shell 307 may serve as a housing for the tube bundle having a plurality of tubes 308 and the void 310. The thin wall tube 308 may be designed for condensing and boiling heat transfer. Any heat that escapes from the hot fluid (e.g. exhaust gas) inside the tube 308 may be transferred into the cold fluid (e.g. boiler feed water) that surrounds the tube 308, instead of potentially transferring into the environment outside of the shell 307. The tubes 308 may be made of plastic material, such as polymer, which allows the tube wall 309 to be formed ultra-thin. The diameter of each plastic tube 308 may be significantly reduced, and accordingly, the number of tubes 308 in the tube bundle may be considerably increased compared to the conventional heat exchanger, such as metallic heat exchanger. This plastic tube 308 structure may lead to the increase of the surface area for heat exchange, enhancing the heat recovery efficiency.

FIG. 3A illustrates the single tube 308 and the void 310 inside the shell 307 of the P-HEX 302 for explanation convenience. The left side of the wall 309 of tube 308 is a tube side, and the right side of the wall 309 is a void side. The operating regions inside the P-HEX 302 may include both sensible heat Q_{SH} transfer and latent heat Q_{LH} transfer. The VDR system 300 for the combined latent and sensible heat recovery may require the P-HEX 302 to operate in gas-to-gas, liquid-to-liquid, and gas-to-liquid heat transfer modes, as shown in FIG. 3A. Initially, as the exhaust gas 311 with low-level waste heat (e.g. approximately 150° C.) traverses the P-HEX 302, only sensible heat Q_{SH} of the exhaust gas 311 may be exchanged through the thin walls 309 that separates the inside of the tubes 308 from the void 310 surrounding the tube 308. Then, when the exhaust gases 311 exchange heat with the boiler feed water 314, which is low temperature (e.g. approximately 20° C.), through the thin walls 309 of tubes 308, the temperature of the exhaust gases 311 may be reduced. The gradual reduction in temperature below the dew point temperature may prompt the condensation 312 of water vapor present in the exhaust gases 311. As the vapor transitions to a liquid state, the latent heat Q_{LH} of condensation 312 may be liberated. Accordingly, the combination of the latent heat Q_{LH} and sensible heat Q_{SH} may form boiling water 316 from the boiler feed water and then generate low-pressure steam 318 (e.g. approximately 0.2 atm at approximately 60° C.). The boiler feed water may reduce the temperature of exhaust gas and also turn to boiling water by the sensible and latent heat. As vapor condenses out of the exhaust gas it may release additional heat (latent heat Q_{LH}). Simultaneously, there is the sensible heat that is transferred from higher temperatures to lower temperatures. This two-phase flow may offer 10 times higher heat transfer coefficient, significantly increasing the overall thermal efficiency. In some embodiments, the VDR system 300 may operate for all flow configurations including counter-flow, cross-flow, and co-flow.

The phase separator 304 may be connected to the tube 308 and separate condensates (liquids) from non-condensable gases. This may facilitate the management of exhaust products for reuse or venting. The vacuum pump 306 may include the source of energy, typically electricity and a motor, as well as hardware to create a vacuum. It may use other forms of motive energy, such as steam and high pressure liquids as appropriate for a given application. As shown in FIG. 3A, the hot fluid (e.g. exhaust gas with low-level waste heat) may enter the tube 308 of the P-HEX 302 through a hot fluid inlet 322, and the condensates and/or non-condensable gases from the exhaust gas may be expelled from the P-HEX 302 through a hot fluid outlet 324. For simplicity's sake, the condensates and/or non-condensable gases exiting from the outlet 324 is referred to as hot fluid even though it is cooled. The cold fluid (e.g. boiler feed water) may enter the void 310 of the P-HEX 302 through a cold fluid inlet 326, and a low-pressure steam may be transferred from the P-HEX 302 to the vacuum pump 306 through a cold fluid outlet 328. For simplicity's sake, the low-pressure steam exiting from the outlet 328 is referred to as cold fluid even though it is heated.

FIG. 3C depicts a schematic structure of a VDR system 350, according to another embodiment. The VDR system 350 may be similar to the VDR system 300 shown in FIG. 3A, but there are differences in that cold fluid (e.g. boiler feed water) is supplied through a tube 358, while hot fluid (e.g. exhaust gas) is supplied through void 310 in between the plurality of tubes 360. Specifically, referring to FIG. 3C, the VDR system 350 may include a P-HEX 352, a phase separator 304, a vacuum pump 306, and a vapor compressor (not shown). The P-HEX 352 may include a cylindrical shell 357 and a tube bundle including a plurality of tubes 358 with thin walls 359 inside the shell 357. The P-HEX 352 also includes the void 360 in between the plurality of tubes 358, and the tube wall 359 is located in between the inside of the tube 358 and the void 360. The shell 357 may serve as a housing for the tube bundle having a plurality of tubes 358 and the void 360. The thin wall tube 358 may be designed for condensing and boiling heat transfer. Any heat that escapes from the hot fluid (e.g. exhaust gas) through the void 360 may be transferred into the cold fluid (e.g. boiler feed water) inside the tube 358, instead of potentially transferring into the environment outside of the shell 357. As mentioned above, the tubes 358 may be made of plastic material, such as polymer, which allows the tube wall 359 to be formed ultra-thin. The diameter of each plastic tube 358 may be significantly reduced, and accordingly, the number of tubes 358 in the tube bundle may be considerably increased compared to the conventional heat exchanger, such as metallic heat exchanger. This plastic tube 358 structure may lead to the increase of the surface area for heat exchange, enhancing the heat recovery efficiency.

FIG. 3C illustrates the single tube 358 and the void 360 inside the shell 357 of the P-HEX 352 for explanation convenience. The left side of the wall 359 of tube 358 is a void side, and the right side of the wall 359 is a tube side. The operating regions inside the P-HEX 352 may include both sensible heat Q_{SH} transfer and latent heat Q_{LH} transfer. The VDR system 350 for the combined latent and sensible heat recovery may require the P-HEX 352 to operate in gas-to-gas, liquid-to-liquid, and gas-to-liquid heat transfer modes. Initially, as the exhaust gas 361 with low-level waste heat (e.g. approximately 150° C.) traverses the void 360 of the P-HEX 352, only sensible heat Q_{SH} of the exhaust gas 361 may be exchanged through the thin walls 359 that separates the inside of the tubes 358 from the void 360 surrounding the tube 358. Then, when the exhaust gases 361 exchange heat with the boiler feed water 364, which is low temperature (e.g. approximately 20° C.), through the thin walls 359 of tubes 358, the temperature of the exhaust gases 361 may be reduced. The gradual reduction in temperature below the dew point temperature may prompt the condensation 362 of water vapor present in the exhaust gases 361. As the vapor transitions to a liquid state, the latent heat Q_{LH} of condensation 362 may be liberated. Accordingly, the combination of the latent heat Q_{LH} and sensible heat Q_{SH} may form boiling water 366 from the boiler feed water and then generate low-pressure steam 368 (e.g. approximately 0.2 atm at approximately 60° C.). The boiler feed water may reduce the temperature of exhaust gas and also turn to boiling water by the sensible and latent heat. As vapor condenses out of the exhaust gas it may release additional heat (latent heat Q_{LH}). Simultaneously, there is the sensible heat that is transferred from higher temperatures to lower temperatures. This two-phase flow may offer 10 times higher heat transfer coefficient, significantly increasing the overall thermal efficiency.

The phase separator 354 may be connected to the void 360 and separate condensates (liquids) from non-condensable gases. This may facilitate the management of exhaust products for reuse or venting. The vacuum pump 356 may include the source of energy, typically electricity and a motor, as well as hardware to create a vacuum. It may use other forms of motive energy, such as steam and high pressure liquids as appropriate for a given application. As shown in FIG. 3C, the hot fluid (e.g. exhaust gas with low-level waste heat) may enter the void 360 of the P-HEX 352 through a hot fluid inlet 372, and the condensates and/or non-condensable gases from the exhaust gas may be expelled from the P-HEX 352 through a hot fluid outlet 374. For simplicity's sake, the condensates and/or non-condensable gases exiting from the outlet 374 is referred to as hot fluid even though it is cooled. The cold fluid (e.g. boiler feed water) may enter the tube 358 of the P-HEX 352 through a cold fluid inlet 376, and a low-pressure steam may be transferred from the P-HEX 352 to the vacuum pump 356 through a cold fluid outlet 378. For simplicity's sake, the low-pressure steam exiting from the outlet 378 is referred to as cold fluid even though it is heated.

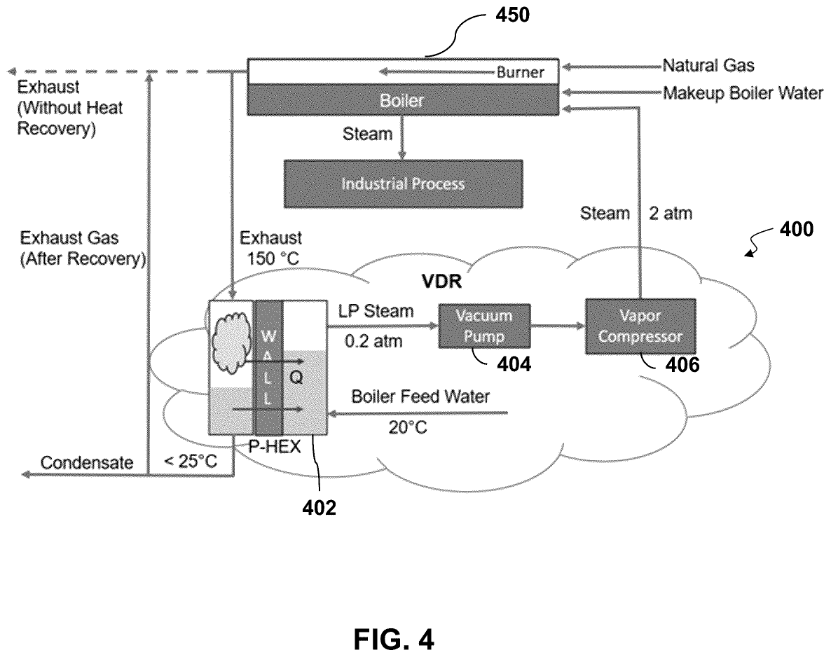

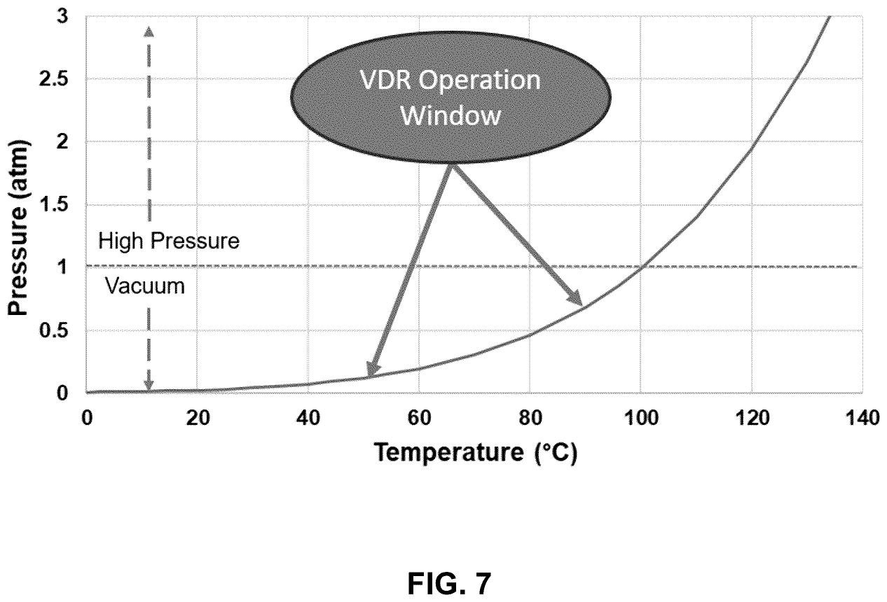

FIG. 4 depicts a VDR system 400 integrated with a boiler 450, according to one embodiment. Referring to FIG. 4, the VDR system 400 with its three major components, including a P-HEX 402, a vacuum pump 404, and a vapor compressor 406, may be integrated with a host site boiler 450. FIG. 4 also shows the estimated temperatures of the hot fluid (e.g. exhaust gas) and cold fluid (e.g. boiler feed water) for maximizing sensible and latent heat Q transfer according to one embodiment. Specifically, the boiler 450 may generate steam with the provided natural gas and boiler water using a burner and expel exhaust gases with heat. The exhaust gases with certain temperature (e.g. approximately 150° C.) may be transferred to the P-HEX 402. As described above with FIGS. 3A to 3C, the P-HEX 402 may exchange sensible and latent heat Q using the thin wall tube and boiler feed water (e.g. approximately 20° C.) and may form steam with a low pressure (e.g. approximately 0.2 atm). The exhaust gases after the heat recovery may be expelled as condensate and/or as non-condensable gases. The condensate may be a vapor that condensed out of the gas and into a liquid form and may be leaving through the path of the phase separator at temperatures less than approximately 25° C. In some cases, some of the exhaust gases from the boiler 450 may be expelled without heat recovery. The low-pressure steam (e.g. approximately 0.2 atm) may be transferred to a vacuum pump 404 and then to a vapor compressor 406. The vacuum pump 404 may reduce the operating pressure for the boiler feed water side. This vacuum operation may lower the boiling point of water from approximately 100° C. to the temperature corresponding to the new pressure (see FIG. 7). This lower temperature may result in an increased average ΔT throughout the P-HEX 403 to improve heat transfer. The pressure of the steam may be increased (e.g. approximately 2 atm) by the vapor compressor 406, and then the steam with the increased pressure may be supplied to the boiler 450. The boiler 450 may use this steam on the industrial process. The VDR system 400 integrated with the boiler 450 may provide efficient recovery and upgrade of sensible and latent heat.

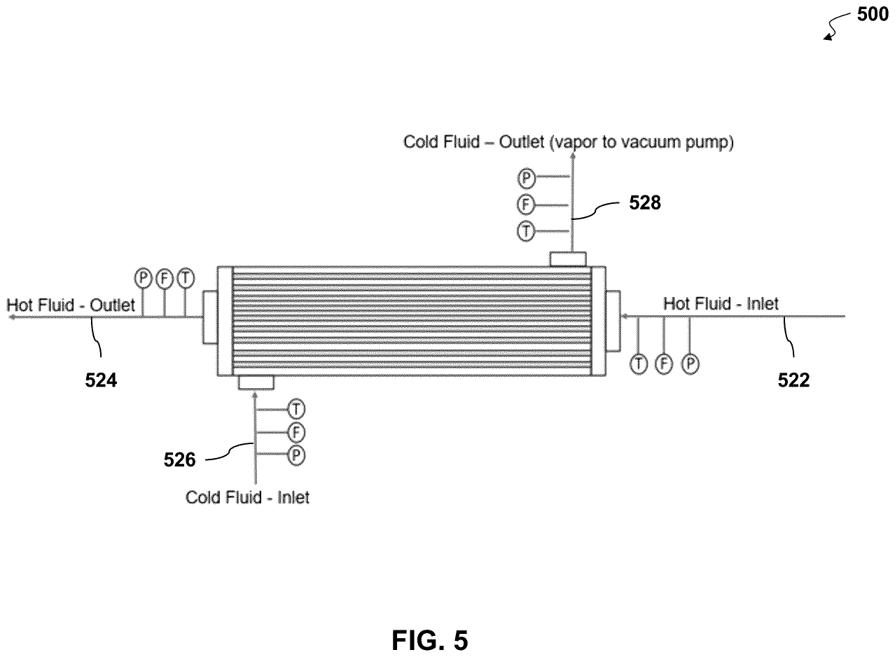

FIG. 5 depicts a schematic structure of a P-HEX 500 of a VDR system to explain an operating window of the P-HEX 500, according to one embodiment. Referring to FIG. 5, the P-HEX 500 may include a hot fluid inlet 522, a hot fluid outlet 524, a cold fluid inlet 526, and a cold fluid outlet 528. For simplicity's sake, the hot fluid inlet 522 and hot fluid outlet 524 may be the same stream. This may extend to the cold fluid as well. The cold fluid inlet 526 and cold fluid outlet 528 may be the same stream. Referring to FIGS. 3A and 3B alongside FIG. 5, the hot fluid (e.g. exhaust gas) entered through the hot fluid inlet 522 may travel through one of the tube and void surrounding the tube, while the cold fluid (e.g. boiler feed water) entered through the cold fluid inlet 326, 526 travels through the other of the tube and the void surrounding the tube inside the shell. This design may reduce the heat losses through the shell to the environment. Heat may travel from the hot fluid (e.g. exhaust gas), through the tube wall and into the cold fluid (e.g. boiler feed water). If the hot fluid was on the void inside the shell, there would likely be efficiency losses as the heat is more likely to escape to the environment.

The operating window of the P-HEX 500 may be a sub-atmospheric pressure and a heat source below approximately 100° C. The P-HEX 500 operation under vacuum, a key innovation in the VDR system, may result in vaporization of boiler feed water using low-level waste heat from exhaust gases, at temperatures well below approximately 100° C. (212° F.). The vapor compressor may compress low-pressure steam to a higher pressure (approximately 1 to 5 atm) for seamless integration with the boiler and/or host site industrial processes. The heat of compression of low-pressure steam may result in slightly superheated steam for additional benefits. This combination of P-HEX with a vacuum pump and vapor compressor may take low-temperature (e.g. approximately 150° C. (300° F.)) and combustion exhaust gases from any source and recover the heat to within ambient temperature (e.g. approximately 20° C., preferably within approximately 5° C. (9° F.)). In some embodiments, the vacuum operating pressure may range from approximately 0 to approximately 0.9 atm, with a preferred range of approximately 0.2 to approximately 0.7 atm, in order to provide sufficient benefits, while not dramatically impacting the efficiency of the system.

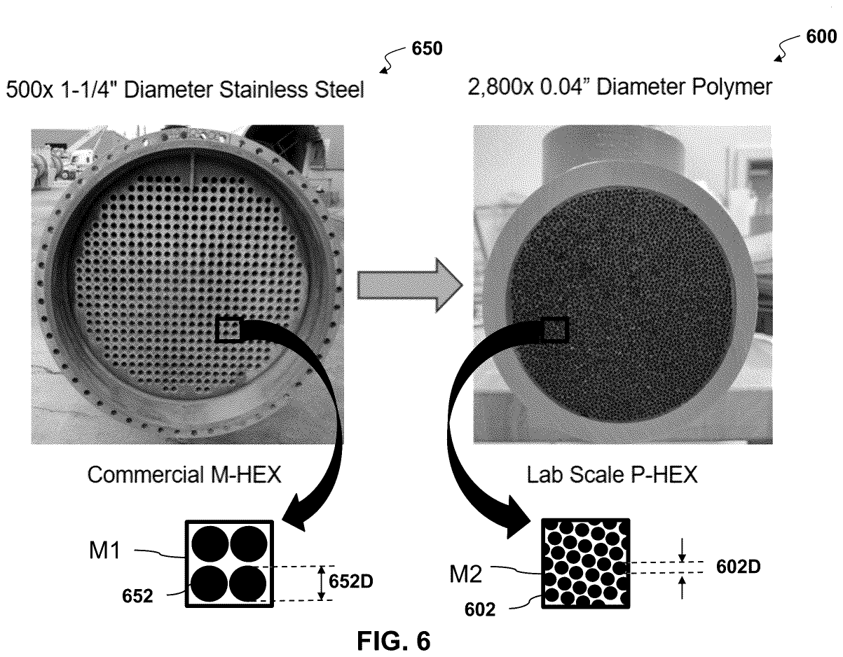

FIG. 6 depicts a comparison of tube diameters 602D, 652D of a P-HEX 600 of the present disclosure and a conventional heat exchanger 650 (e.g. metallic heat exchanger (M-HEX)), according to one embodiment. FIG. 6 also includes the magnified view M1 of tubes 652 of the conventional heat exchanger 650 and the magnified view M2 of tubes 602 of the P-HEX 600. As mentioned above, the VDR system may introduce a transformative approach to waste heat recovery by integrating a modular, advanced P-HEX with a vacuum pump and vapor compressor, providing a functional and structural evolution from traditional latent heat recovery devices.

Referring to FIG. 6, the P-HEX 600 of the present disclosure may provide a dramatically increased surface area packing density by utilizing ultra-thin plastic (e.g. polymer) tubes 602 within its structure. The ultra-thin plastic (e.g. polymer) tubes 602 of P-HEX 600 may be specifically designed to maximize the surface area available for heat exchange, which is a critical factor in enhancing the efficiency of low-level waste heat recovery. Specifically, the conventional heat exchanger 650 (e.g. commercial M-HEX) is made of stainless steel, metallic materials, or the like, and the diameter 652D reduction of each tube 652 of the conventional heat exchanger 650 made of stainless steel is limited due to constraint or restriction in manufacturing. On the other hand, the P-HEX 600 may be made of a plastic material such as different types of polymers, and thus the diameter 602D of each tube 602 is significantly reduced. In some embodiments, the plastic material for the P-HEX 600 may include but not limited to at least one of: Polypropylene, Polyethylene, Ethylene tetrafluoroethylene, Polytetrafluoroethylene, Polyether Ether Ketone, Ethylene Chlorotrifluoroethylene, Fluorinated Ethylene Propylene, Liquid Crystal Polymer, Polyamide, Nylon, Polybenzimidazole, Polychlorotrifluoroethylene, Polyetherimide, Polyether sulfone, Polyimide, Polymethylpentene, Polyoxymethylene, Polyphenylene sulfide, Polyphenylsulfone, Polypropylene Homopolymer, Polysulfone, and Polyvinylidene fluoride. As shown in FIG. 6, the diameter 602D of each tube 602 of the P-HEX 600 may be much smaller than the diameter 652D of each tube 652 of the conventional heat exchanger 650, and accordingly, the P-HEX 600 may have an increased tube packing density. In some embodiments, the diameter 652D of each tube 652 of the conventional heat exchanger 650 may be approximately 1¼ inches, whereas the diameter 602D of each tube 602 of the P-HEX 600 may be approximately 0.04 inches. Accordingly, the P-HEX 600 may have approximately 2,800 tubes, while the conventional heat exchanger 650 may have only approximately 500 tubes. The small diameter tubes of the P-HEX 600 may significantly increase a surface area for low-temperature heat recovery.

By utilizing ultra-thin plastic (e.g. polymer) tubes 602 within its structure, the P-HEX 600 may significantly increase the surface area compared to traditional heat exchangers 650, without a corresponding increase in physical size. This design innovation allows for a more effective transfer of heat at lower temperature gradients, overcoming one of the key limitations of low-level waste heat recovery.

FIG. 7 depicts a graph for showing an operating window of a VDR system for water with respect to temperature and pressure, according to one embodiment. As shown in the graph of FIG. 7, the pressure gradient may be used to increase or control temperature gradient, this use of pressure gradient and temperature gradient may maximize low-level heat recovery.

Specifically, the VDR system may perform vacuum-assisted heat upgrade. At atmospheric pressure, water may not boil below approximately 100° C. as shown in FIG. 7. Utilizing a vacuum pump, the VDR system may capture sensible and latent heat from exhaust gases more effectively. The vacuum may create and maintain a lower pressure environment inside the void of the shell of P-HEX, allowing for the vaporization of boiler feed water at temperatures below its boiling point of approximately 212° F. (100° C.). Consequently, this leads to a greater driving force for heat transfer. On the tube side where the hot fluid enters, a higher pressure may be beneficial to obtain the full benefit of latent heat. This recovery temperature of the VDR system is significantly lower than that of conventional systems. In the case where other fluids are used in the VDR system, the temperature may correspond to their boiling point.

Meanwhile, the vapor compressor in the VDR system may serve to pressurize the steam containing the recovered heat into a more valuable form. That is, the vapor compression in the VDR system may allow heat to be upgraded. The heat of compression may superheat the steam while preventing any condensation due to pressurization. This innovation allows the VDR system to not only recover waste heat but also upgrade it to standards required for industrial processes, enhancing the usability of recovered energy.

In general, low-level heat recovery may be extremely expensive because conventional methods do not work effectively due to low temperature difference ΔT (low driving force). However, the VDR system may efficiently achieve low-level heat recovery in the same environment. The P-HEX with a vacuum pump followed by a vapor compressor may recover over approximately 80% of waste heat. These features are differentiated from the conventional systems and methods due to the following several factors.

First, the VDR system has the integrated system design. The limitation of low driving force (low ΔT) may be removed by use of a pressure gradient, leading to a higher effective temperature gradient. Both the driving force benefits of the temperature gradient and the pressure gradient are uniquely integrated in one system. The VDR system uniquely combines a vacuum pump and vapor compressor with the P-HEX. This integration is not merely additive but synergistic, enhancing the performance of each component and the system as a whole. The condensation of water vapor from exhaust gases at atmospheric pressure or higher, while vaporizing water under vacuum in one component, is not found in the conventional solutions. The use of a vapor compressor to then elevate the energy level of the recovered steam for practical use may leverage thermal dynamics.

In addition, plastic materials for heat transfer of VDR system dramatically increases the waste heat recovery. The P-HEX performs greater than 80% heat recovery while any of the conventional heat exchangers does not achieve 80% recovery rate of waste heat. The polymer materials in heat exchangers challenges conventional practices since polymers are poor conductors for heat and thus typically have not been used in heat recovery applications. Other limitations include temperature tolerance and durability. Despite these limitations, the VDR system utilizes beneficial aspects of plastic materials in developing ultra-thin tubes, ultimately achieving the significant increase in efficiency of low-level waste heat recovery.

Furthermore, the VDR system may allow optimization for low-temperature efficiency. The specific focus on maximizing low-level heat recovery and reuse may address a commonly overlooked gap in heat recovery technology. Heat recovery systems are not typically designed to efficiently manage and upgrade low-level heat, focusing instead on higher temperature differentials.

Last but not least, the VDR system may also have economic impact. The VDR system design may be the integration of proven components, such as a vacuum pump and vapor compressor, with commercially unavailable component P-HEX. In general, concerns may exist about the electrical costs of operating the vapor compressor and vacuum pump. However, the component integration of VDR system may reduce the overall cost by beneficially utilizing the heat of compression (parasitic losses) to superheat steam produced under vacuum.

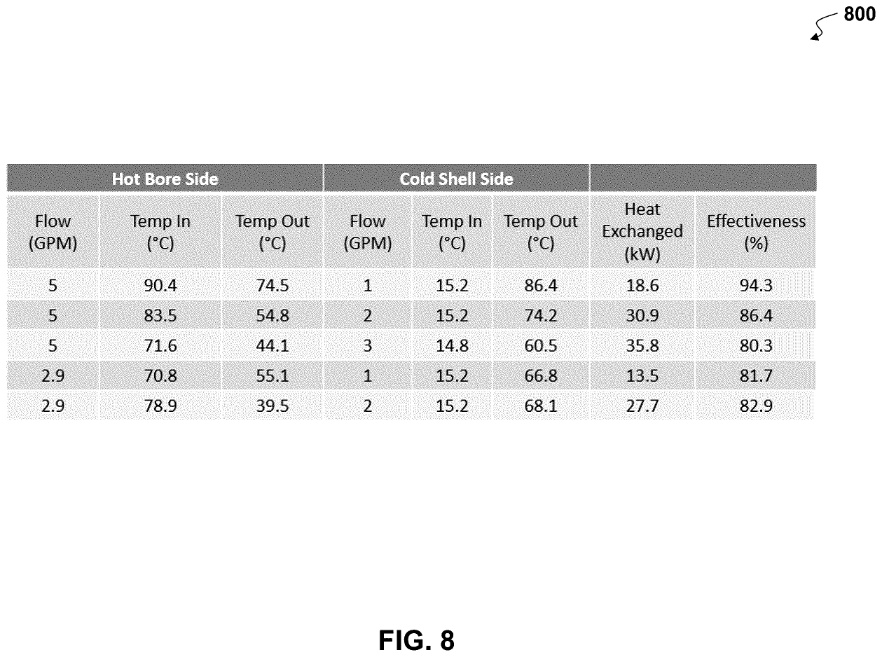

FIG. 8 is a table for showing test performances of a P-HEX of a VDR system in real environment, according to one embodiment. The feasibility of P-HEX is proven recently under California Energy Commission and Department of Energy projects as shown in the table in FIG. 8. The “hot bore side” may mean a tube section inside a shell, and the “cold shell side” may mean a void section inside the shell.

As mentioned above, the VDR system of the present disclosure have advantages over the conventional systems and methods. First, the VDR system may perform over approximately 80% recovery and upgrade of all low-level waste heat. The VDR system may be capable of recovering over 80% of all waste heat, including latent and sensible heat, before upgrading to higher-value steam for reuse. Second, the system has significantly enhanced boiler efficiency. The VDR system enables boiler thermal efficiencies of up to approximately 95%, matching and exceeding the capabilities of the most efficient condensing economizers. Third, the VDR system may enable up to 20% reduction in fuel use. The system would reduce energy consumption in diverse industries such as manufacturing, chemical production, food and beverage processing, by up to 16 billion therms per year. Fourth, the system may reduce Greenhouse Gas (GHG) Emissions. The VDR system may help to reduce GHG emissions by up to 90 million tons/year in the U.S. manufacturing sector alone. Fifth, the VDR system may operate in a lower temperature. The system is optimized to function efficiently at temperatures below approximately 100° C., a range where the conventional solutions are less effective. This capability allows the VDR system to extract and upgrade low-grade heat that would otherwise be wasted. Lastly, the VDR system may reduce capital and operational costs. The VDR system may use significantly lower cost materials and components compared to the conventional solutions, leading to up to approximately 80% reductions in capital costs. The system may also minimize physical footprint and weight, leading to lower shipping, installation, and operational costs compared to bulkier prior solutions.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
a heat exchanger including:
a shell including a first section and a second section, wherein one of the first section and the second section is one or more tubes disposed inside the shell, and the other is a void surrounding the one or more tubes inside the shell;
the first section configured to receive hot fluid and recover heat from the hot fluid;
the second section configured to receive cold fluid and generate steam using the recovered heat;
a vacuum pump configured to lower a pressure of the second section inside the shell and receive the steam from the second section; and
a vapor compressor configured to receive the steam from the vacuum pump and pressurize the steam.

2. The system of claim 1, wherein the vacuum pump is connected to the second section inside the shell, and wherein the vapor compressor is connected to the vacuum pump.

3. The system of claim 1, wherein the recovered heat includes both sensible heat and latent heat that are recovered from the hot fluid.

4. The system of claim 3, wherein the latent heat is generated by condensation of water vapor present in the hot fluid inside the one or more tubes through heat exchange with the cold fluid inside the void surrounding the one or more tubes.

5. The system of claim 3, wherein the steam is generated by vaporization of the cold fluid inside the second section using at least one of the sensible heat and latent heat transferred from the first section, under a lowered pressure by the vacuum pump.

6. The system of claim 5, wherein the lowered pressure inside the second section lowers a boiling point of the cold fluid.

7. The system of claim 5, wherein a pressure inside the void inside the shell is lower than a pressure inside the one or more tubes.

8. The system of claim 1, wherein the system is connected to a boiler, wherein the hot fluid is exhaust gas expelled from the boiler, and the cold fluid is boiler feed water.

9. The system of claim 8, wherein the pressurized steam has an increased pressure and is supplied to the boiler for reuse.

10. The system of claim 1, wherein the one or more tubes are made of a plastic material.

11. The system of claim 1, wherein the one or more tubes are made of at least one of: Polypropylene, Polyethylene, Ethylene tetrafluoroethylene, Polytetrafluoroethylene, Polyether Ether Ketone, Ethylene Chlorotrifluoroethylene, Fluorinated Ethylene Propylene, Liquid Crystal Polymer, Polyamide, Nylon, Polybenzimidazole, Polychlorotrifluoroethylene, Polyetherimide, Polyether sulfone, Polyimide, Polymethylpentene, Polyoxymethylene, Polyphenylene sulfide, Polyphenylsulfone, Polypropylene Homopolymer, Polysulfone, and Polyvinylidene fluoride.

12. The system of claim 1, further comprising a phase separator, wherein the phase separator is connected to the first section and configured to separate condensates from non-condensable fluid in the hot fluid.

13. A method comprising:
receiving hot fluid via a first section of a heat exchanger;
receiving cold fluid inside a second section of a heat exchanger;
lowering a pressure inside the second section by a vacuum pump;
recovering heat from the hot fluid through heat exchange with the cold fluid;
generating steam inside the second section using the recovered heat; and
pressurize the steam by a vapor compressor,
wherein one of the first section and the second section is one or more tubes disposed inside a shell of the heat exchanger, and the other of the first section and the second section is a void surrounding the one or more tubes inside the shell.

14. The method of claim 13, wherein the recovered heat includes both sensible heat and latent heat.

15. The method of claim 13, wherein the recovered heat is generated by condensation of water vapor present in the hot fluid inside the first section.

16. The method of claim 13, wherein the steam is generated by vaporization of the cold fluid inside the second section using at least one of sensible heat and latent heat of the recovered heat transferred from the first section, under a lowered pressure by the vacuum pump.

17. The method of claim 13, wherein the lowered pressure inside the second section lowers a boiling point of the cold fluid.

18. The method of claim 13, wherein the hot fluid is exhaust gas expelled from a boiler, and the cold fluid is boiler feed water, and wherein the method further comprises: supplying the pressurized steam to the boiler for reuse.

19. The method of claim 13, wherein the first section are made of a plastic material.

20. The system of claim 13, further comprising separating condensates from non-condensable fluid in the hot fluid by a phase separator connected to the first section.
